(19) United States
(12) Patent Application Publication
(10) Pub. No.: US 2012/0213445 A1
(43) Pub. Date: Aug. 23, 2012

(54) METHOD, APPARATUS AND SYSTEM FOR RATING IMAGES

(75) Inventors: David Ngan LUU, Balgownie (AU); Rob SANGSTER, Mosman (AU)

(73) Assignee: CANON KABUSHIKI KAISHA, Tokyo (JP)

(21) Appl. No.: 13/371,305

(22) Filed: Feb. 10, 2012

(30) Foreign Application Priority Data
Feb. 17, 2011 (AU) 2011200696

(51) Int. Cl. G06K 9/68

(52) U.S. Cl. 382/218

(57) ABSTRACT

A method of rating a captured image is disclosed. A database of reference images is accessed. One or more of the reference images has an associated rating value. One or more of the reference images is selected to form at least one subset of reference images based on metadata associated with the reference images. The reference images of the subset are captured approximate to a capture location of the captured image and at a time associated with a capture time of the captured image. One or more similar reference images are determined from the selected subset based on at least one characteristic of the captured image. The captured image is rated based on the rating values associated with the similar reference images.

REFERENCE TO RELATED PATENT APPLICATIONS

This application claims the benefit under 35 U.S.C. §119 of the filing date of Australian Patent Application No. 2011200696, filed 17 Feb. 2011, hereby incorporated by reference in its entirety as if fully set forth herein.

### FIELD OF INVENTION

The current invention relates to ranking user images using information obtained from an image database and, in particular, to a method and apparatus for rating an image. The current invention also relates to a computer readable medium having recorded thereon a computer program for rating an image.

### DESCRIPTION OF BACKGROUND ART

Modern digital cameras often include compact flash-based digital storage, which allows users to capture a large number of digital images and store the digital images on the camera before eventually saving or printing the images. Such digital images may include, for example, electronic photographs captured with a digital camera or scanned from an original document.

The ability to capture and store such a large quantity of images poses difficulties for users in selecting images for printing or further processing. The stored images are often unclassified meaning that the images have not been sorted according to some criteria. The difficulties arise in the fact that users typically require a long period of time to manually search through the unclassified collection of images and select the images desired for printing or further processing. The problem is further exacerbated by the fact that many of the captured images are of a similar setting.

When creating photo merchandise, a collection of images may need to be reduced to a minimum set of visually compelling images, in order to make the process of constructing the merchandise manageable. The collection of images may be reduced by manually searching through the collection. However, such searching is typically a long and tedious process.

Some methods of automatically selecting images from among multiple images involve clustering images into groups and ordering the images based on image quality. One of the images may then be selected based on the image quality. However, image quality is not necessarily a good indicator of what makes an image interesting to an observer.

Thus, a need exists for an improved method of rating an image.

### SUMMARY OF THE INVENTION

It is an object of the present invention to substantially overcome, or at least ameliorate, one or more disadvantages of existing arrangements.

According to one aspect of the present disclosure there is provided a method of rating a captured image, said method comprising the steps of:

accessing a database of reference images, one or more of the reference images having an associated rating value;

selecting one or more of the reference images to form at least one subset of reference images based on metadata associated with the reference images, the reference images of said subset being captured at an event determined by a function of to a capture location of the captured image and a time associated with a capture time of the captured image;

determining one or more similar reference images from the selected subset based on at least one characteristic of the captured image; and

rating the captured image based on the rating values associated with the similar reference images.

According to another aspect of the present disclosure there is provided an apparatus for rating a captured image, said apparatus comprising:

accessing means for accessing a database of reference images, one or more of the reference images having an associated rating value;

selecting means for selecting one or more of the reference images to form at least one subset of reference images based on metadata associated with the reference images, the reference images of said subset being captured at an event determined by a function of a capture location of the captured image and a time associated with a capture time of the captured image;

determining means for determining one or more similar reference images from the selected subset based on at least one characteristic of the captured image; and

rating means for rating the captured image based on the rating values associated with the similar reference images.

According to still another aspect of the present disclosure there is provided a system for rating a captured image, said system comprising:

a memory for storing data and a computer program;

a processor coupled to said memory for executing said computer program, said computer program comprising instructions for:
accessing a database of reference images, one or more of the reference images having an associated rating value;
selecting one or more of the reference images to form at least one subset of reference images based on metadata associated with the reference images, the reference images of said subset being captured at an event determined by a function of a capture location of the captured image and a time associated with a capture time of the captured image;
determining one or more similar reference images from the selected subset based on at least one characteristic of the captured image; and
rating the captured image based on the rating values associated with the similar reference images.

According to still another aspect of the present disclosure there is provided a computer readable medium comprising a computer program stored thereon for rating a captured image, said program comprising:

code for accessing a database of reference images, one or more of the reference images having an associated rating value;

code for selecting one or more of the reference images to form at least one subset of reference images based on metadata associated with the reference images, the reference images of said subset being captured at an event determined by a function of a capture location of the captured image and a time associated with a capture time of the captured image;

code for determining one or more similar reference images from the selected subset based on at least one characteristic of the captured image; and

code for rating the captured image based on the rating values associated with the similar reference images.

Other aspects of the invention are also disclosed.

### BRIEF DESCRIPTION OF THE DRAWINGS

One or more embodiments of the invention will now be described with reference to the following drawings, in which:

FIGS. 1A, 1B and 1C form a schematic block diagram of a computer system upon which arrangements described may be practiced;

FIG. 2 shows types of metadata that may be associated with an image;

FIG. 3 is a graph showing the number of images captured at a particular location over a period of time; and

FIG. 4 is a schematic flow diagram showing a method of rating a captured image.

### DETAILED DESCRIPTION OF EMBODIMENTS OF THE INVENTION

Where reference is made in any one or more of the accompanying drawings to steps and/or features, which have the same reference numerals, those steps and/or features have for the purposes of this description the same function(s) or operation(s), unless the contrary intention appears.

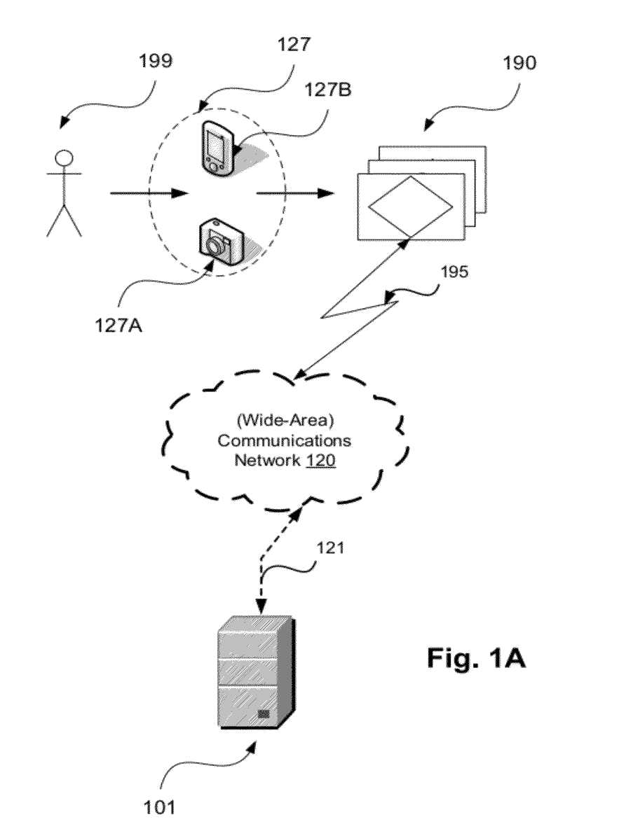

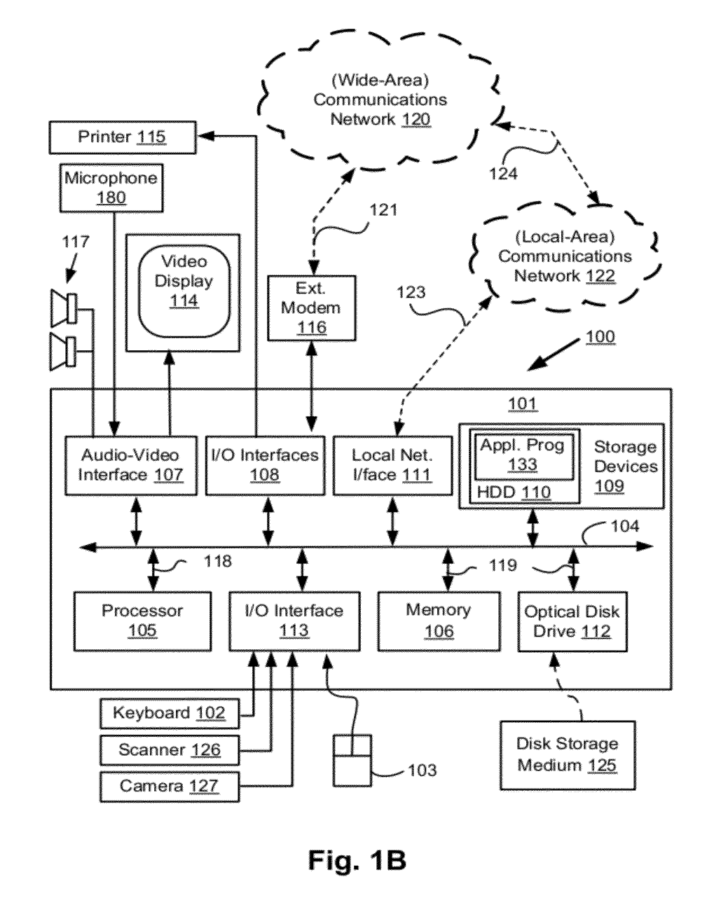

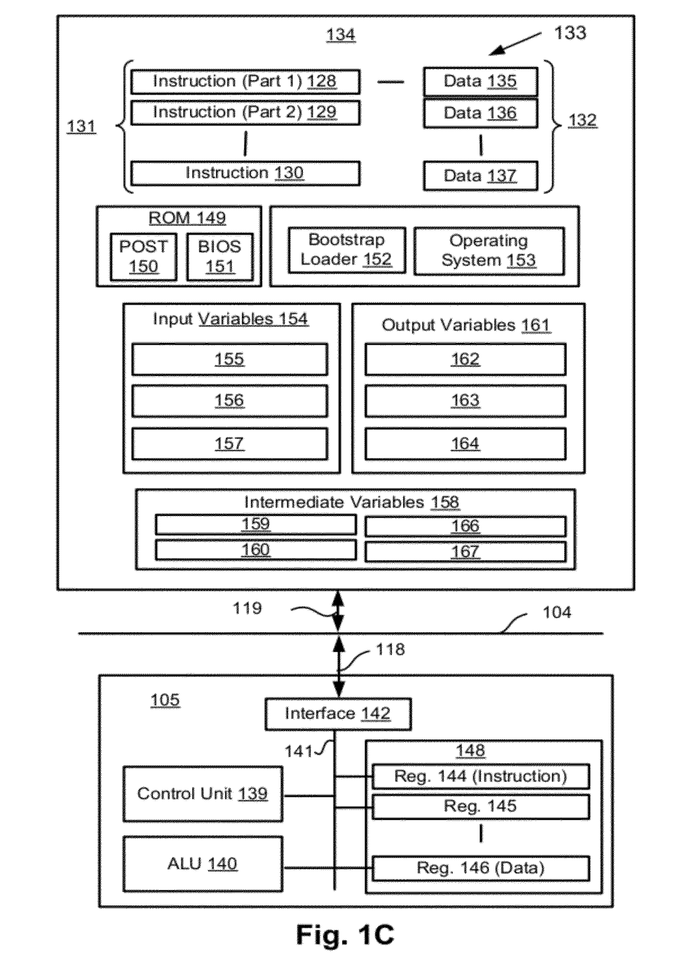

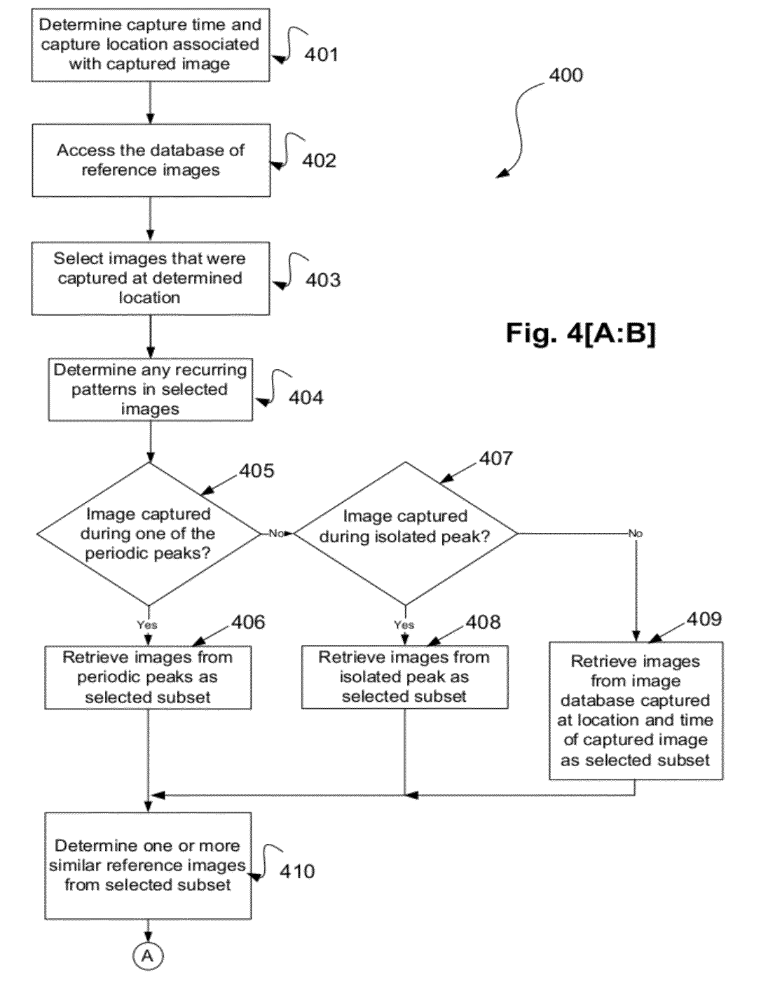

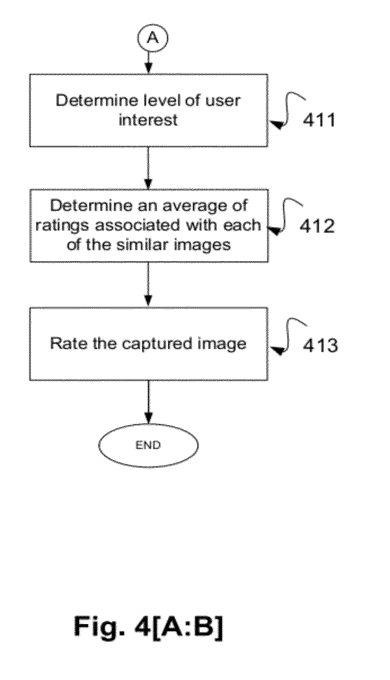

A method 400 (see FIG. 4) of rating an image is described below with reference to FIGS. 1A to 4. FIGS. 1A to 1C show a system 100 on which the method 400 may be implemented. The system 100 may be referred to as a network-based storage and collaborative image rating system. As seen in FIG. 1A, the system 100 comprises image capture devices 127, such as a digital camera 127A or a camera enabled mobile phone 127B, which may be used to capture one or more images 190. The digital camera 127A and the mobile phone 127B will be generically referred to as the image capture device 127 unless specifically referred to.

The image capture device 127 may be enabled for wireless communication. The image capture device 127 may send versions of the captured image 190 over a wireless network 195 (such as WiFi or 3G) to a central server computer module 101. The wireless network 195 may connect to a communications network 120 and data communications may be carried out over the network 120 to which the server computer module 101 is also connected.

The described methods may be used for determining the level at which the image 190 captured by a user 199 is considered interesting. The described methods use statistical analysis to determine either recurring spikes in image uploads to an image database configured within the server 101, or abnormally high amounts of images captured at a particular time in a particular capture location.

FIGS. 1B and 1C show the system 100 in more detail. As seen in FIG. 1B, the system 100 includes: the server computer module 101; input devices such as a keyboard 102, a mouse pointer device 103, a scanner 126, the image capture device 127, and a microphone 180; and output devices including a printer 115, a display device 114 and loudspeakers 117. An external Modulator-Demodulator (Modem) transceiver device 116 may be used by the server computer module 101 for communicating to and from the communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The server computer module 101 typically includes at least one processor unit 105, and a memory unit 106. For example, the memory unit 106 may have semiconductor random access memory (RAM) and semiconductor read only memory (ROM). The server computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, and optionally a joystick or other human interface device (not illustrated); and an interface 108 for the external modem 116 and printer 115. The I/O interface 113 may also couple to the image capture device 127 when required.

In some implementations, the modem 116 may be incorporated within the computer module 101, for example within the interface 108. The server computer module 101 also has a local network interface 111, which permits coupling of the system 100 via a connection 123 to a local-area communications network 122, known as a Local Area Network (LAN). As illustrated in FIG. 1B, the local communications network 122 may also couple to the wide network 120 via a connection 124, which would typically include a so-called “firewall” device or device of similar functionality. The local network interface 111 may comprise an Ethernet™ circuit card, a Bluetooth™ wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the server computer module 101 typically communicate via an interconnected bus 104 and in a manner that results in a conventional mode of operation of the system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or a like computer systems.

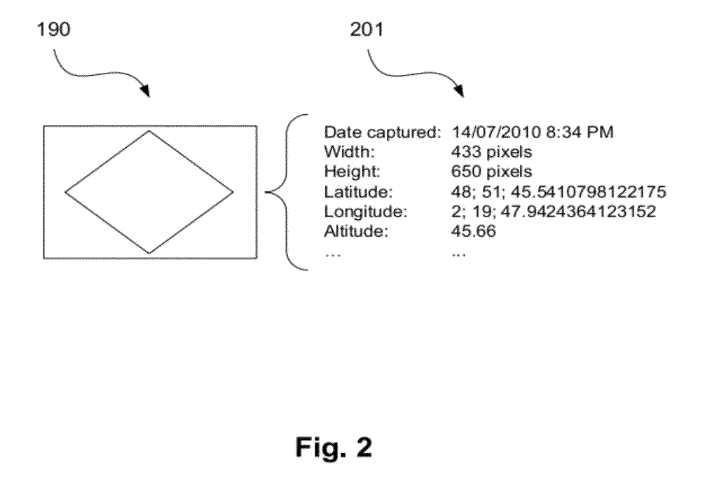

The described methods may be implemented using the system 100 wherein the processes of FIGS. 2 to 7, to be described, may be implemented as one or more software application programs 133 executable within the system 100. In particular, the steps of the described methods are effected by instructions 131 (see FIG. 1C) in the software 133 that are carried out within the system 100. The software instructions 131 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software is loaded into the system 100 from the computer readable medium, and then executed by the system 100. A computer readable medium having such software or computer program recorded on the computer readable medium is a computer program product. The use of the computer program product in the system 100 preferably effects an advantageous apparatus for implementing the described methods.

The software 133 is typically stored in the HDD 110 or the memory 106. The software is loaded into the system 100 from a computer readable medium, and executed by the system 100. Thus, for example, the software 133 may be stored on an optically readable disk storage medium (e.g., CD-ROM) 125 that is read by the optical disk drive 112.

In some instances, the application programs 133 may be supplied to the user encoded on one or more CD-ROMs 125 and read via the corresponding drive 112, or alternatively may be read by the user from the networks 120 or 122. Still further, the software can also be loaded into the system 100 from other computer readable media. Computer readable storage media refers to any non-transitory tangible storage medium that provides recorded instructions and/or data to the system 100 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the server computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1C is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1B.

When the server computer module 101 is initially powered up, a power-on self-test

(POST) program 150 executes. The POST program 150 is typically stored in a ROM 149 of the semiconductor memory 106 of FIG. 1B. A hardware device such as the ROM 149 storing software is sometimes referred to as firmware. The POST program 150 examines hardware within the server computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1B. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the server computer module 101 has sufficient memory in which to execute without colliding with memory allocated to another process. Furthermore, the different types of memory available in the system 100 of FIG. 1B must be used properly so that each process can run effectively. Accordingly, the aggregated memory 134 is not intended to illustrate how particular segments of memory are allocated (unless otherwise stated), but rather to provide a general view of the memory accessible by the system 100 and how such is used.

As shown in FIG. 1C, the processor 105 includes a number of functional modules including a control unit 139, an arithmetic logic unit (ALU) 140, and a local or internal memory 148, sometimes called a cache memory. The cache memory 148 typically include a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 105 waits for a subsequent input, to which the processor 105 reacts to by executing another set of instructions. Each input may be provided from one or more of a number of sources, including data generated by one or more of the input devices 102, 103, data received from an external source across one of the networks 195, 120, 122, data retrieved from one of the storage devices 106, 109 or data retrieved from a storage medium 125 inserted into the corresponding reader 112, all depicted in FIG. 1B. The execution of a set of the instructions may in some cases result in output of data. Execution may also involve storing data or variables to the memory 134.

The described methods use input variables 154, which are stored in the memory 134 in corresponding memory locations 155, 156, 157. The described methods produce output variables 161, which are stored in the memory 134 in corresponding memory locations 162, 163, 164. Intermediate variables 158 may be stored in memory locations 159, 160, 166 and 167.

Referring to the processor 105 of FIG. 1C, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises:
(a) a fetch operation, which fetches or reads an instruction 131 from a memory location 128, 129, 130;
(b) a decode operation in which the control unit 139 determines which instruction has been fetched; and
(c) an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes of FIGS. 2 to 5 is associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

The described methods may alternatively be implemented in dedicated hardware such as one or more integrated circuits performing the functions or sub functions of the described methods. Such dedicated hardware may include graphic processors, digital signal processors, or one or more microprocessors and associated memories. The user 300 uploads the captured image 190 to the server computer module 101. The server computer module 101 then processes the captured image 190 by analysing capture date and capture location metadata associated with the captured image 190. Utilising the metadata, the server computer module 101 may perform statistical analysis on the captured image 190 and other images stored in the server computer module 101 to determine if the captured image 190 is part of a recurring pattern of images uploaded to the server computer module 190. If the captured image 190 is determined to be part of a recurring pattern, then the processor 105 determines that the captured image 190 is part of a series of events. For example, a youth soccer match may regularly occur at a park every Saturday during certain months of the year. As another example, new year's eve fireworks may occur in a particular city every year. If the captured image 190 does not fall into some recurring pattern, but is determined to be part of a large spike in images captured at that time and location, then the processor 105 determines that the captured image 190 is part of a special one off event.

Once the processor 105 has determined that the captured image 190 is part of an event or series of recurring events, then an image similarity method is used to determine images which have been captured at that event or series of recurring events and are similar to the uploaded image 190. Ratings of most similar images are then used to rate and/or rank the captured image 190. If no event pattern can be determined then the captured image 190 is rated against images stored in the server computer module 101, and which were captured at the same time of day and capture location.

The described methods use a database of images configured within the hard disk drive 110 of the server computer module 101. As described below, the images stored within the image database may be used for rating a captured image. The images stored within the image database may be referred to as “reference” images.

The server computer module 101 allows multiple users (e.g., 199) to upload images (e.g., 190) to the reference image database, and view, comment, or rate other images stored in the reference image database and that were captured by other users. Users may upload captured images to the reference image database configured within the hard disk drive 110, and then share the captured images with other users, via the communications network 120. Other users are able to leave feedback on the reference images stored within the reference image database, and also rate the reference images stored within the reference image database.

The described methods may also use existing image databases resident within other remote servers connected to the communications network 120. Such existing image databases may be associated with social networking websites and the like, and may contain thousands of images uploaded by many users. Again, the images of the existing image databases may be used as reference images to rate the captured image 190.

Many of the reference images stored within the reference image database configured within the hard disk drive 110, and the other existing databases, may have been viewed, rated and commented on by the users. Furthermore, many of the reference images contained within the image databases, including the reference image database stored within the server computer module 101, have associated metadata.

The metadata associated with a particular image contains the time (i.e., capture time) that the particular image was captured, and GPS coordinates indicating a location (i.e., a capture location) that the particular image was captured.

As described above, the user 199 may capture an image 190 with the image capture device 127 (e.g., digital camera 127A or mobile device 127B), and then upload the captured image 190 to the server computer module 101. As described above, the server computer module 101 contains an image database configured within the storage module 109. Uploading of the image 190 may be achieved via the communications networks 195, 120 and 122.

As described above, the second part of the application programs 133 and the corresponding code modules mentioned above may be executed to implement one or more graphical user interfaces (GUIs) to be rendered or otherwise represented upon the display 114. The graphical user interfaces may be in the form of a webpage, a desktop or a mobile application.

Once the captured image 190 has been uploaded to the server computer module 101, the processor 105 processes the image 190 by analysing metadata 201 (see FIG. 2) associated with the captured image 190. The capture time and GPS location coordinates (capture location) associated with the image 190 are retrieved by the processor 105 to determine the time and location of where the image was captured.

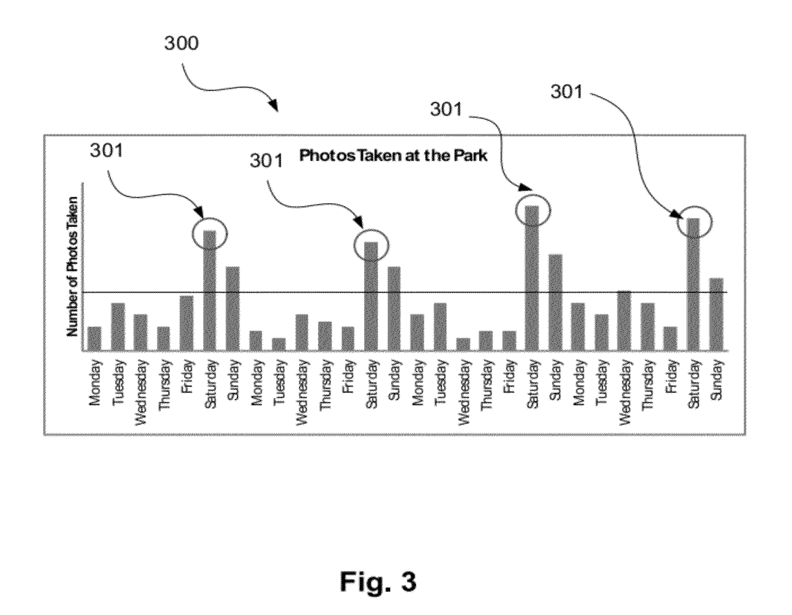

Analysis may be performed on the reference images stored within the image database resident on the server computer module 101 to cluster the reference images based on capture location and capture time associated with each of the images stored within the reference image database. For example, as seen in FIG. 3, for any particular capture location, the processor 105 may generate a graph 300 showing the number of images captured in that location over a period of time. Using statistical methods, peaks 301 in images captured at a particular time for that particular location may be determined by the processor 105. In the example of FIG. 3, periodic peaks 301 in the number of images captured at a park on Saturday and Sundays occur during a four week period. As described below, any recurring patterns in the peaks 301 may be identified in the described methods.

Any suitable pattern recognition method may be used to identify the recurring patterns in the peaks 301. In one implementation, the peaks 301 in the number of photos taken over time can be identified using a threshold. For example, as seen in FIG. 3, line 302 may represent a threshold. Any peaks, such as the peaks 301, above the threshold 302 may be identified. The peaks (e.g., 301) recurring weekly, on weekends, monthly or even yearly may then be grouped and identified as a recurring pattern.

Other suitable pattern recognition methods may also be used to identify the recurring patterns in the peaks 301. For example, U.S. Pat. No. 4,211,237 describes a method of detecting a periodically occurring signal pattern that is part of a signal mixture including interference components. The method of U.S. Pat. No. 4,211,237 stores an amplitude-time waveform pattern of a signal in a computer readable memory and uses the stored waveform pattern to identify subsequent signals. Other examples of suitable pattern recognition methods for use with the described methods are described in the following articles:

1) R. Agrawal, K. I. Lin, H. S. Sawhney, and K. Shim, “Fast similarity search in the presence of noise, scaling, and translation in time-series databases”, In proceedings of the 21st International Conference on Very Large Databases, Zurich, Switzerland, pp 490-501, September, 1995,

2) K. Chan and A. W. Fu, “Efficient time series matching by wavelets”, In proceedings of the 15th IEEE International Conference on Data Engineering, Sydney, Australia, pp 126-133, Mar. 23-26, 1999,

3) X. Ge and P. Smyth, “Deformable Markov model templates for time-series pattern matching”, In proceedings of the 6th ACM SIGKDD International Conference on Knowledge Discovery and Data Mining, Boston, Mass., pp 81-90, Aug. 20-23, 2000,

4) E. Keogh, K. Chakrabarti, M. Pazzani and Mehrotra, “Dimensionality reduction for fast similarity search in large time series databases”, Journal of Knowledge and Information Systems, pp 263-286, 2000, and

5) B. K. Yi, H. Jagadish and C. Faloutsos, “Efficient retrieval of similar time sequences under time warping”, IEEE International Conference on Data Engineering, pp 201-208, 1998.

The pattern recognition method used in the described methods may be configured to have an error tolerance to handle situations where recurring peaks are not exactly periodic. For example, a weekly soccer game may occur in the morning one week, but then at night the next week. The weekly soccer game may also alternate between Saturday one week and Sunday the next. Additionally, the weekly soccer game may not occur on one weekend for some unknown reason.

The described methods seek to identify recurring patterns of image capture by identifying patterns which occur more regularly, such as occurring weekly, and then continue to expand a search period until either a pattern is determined or no pattern is determined

A method 400 of rating a captured image will now be described with reference to FIG. 4. The method 400 may be implemented as one or more software code modules of the software application program 133 resident in the hard disk drive 110 and being controlled in its execution by the processor 105. The method 400 will be described by way of example with reference to the captured image 190. The method 400 determines similar reference images based on at least one characteristic of the captured image 190, such as capture time and/or capture location of the captured image 190.

The method 400 begins at time and location determining step 401, where the processor 105 determines a capture time and capture location for the captured image 190 by analysing the metadata (e.g., 201) associated with the captured image 190. The determined capture time and capture location may be stored in the memory 106.

Then at database accessing step 402, the processor 105 performs the step of accessing the database of reference images configured within the hard disk drive 110. As described above, many of reference images stored within the reference image database have an associated rating value. In one implementation, each of the reference images accessed at step 402 has an associated rating value.

At selecting step 403, the processor 105 performs the step of selecting one or more of the reference images from the reference image database to form at least one subset of reference images based on metadata associated with the selected reference images. In particular, at step 403, the processor 105 analyses the metadata associated with the reference images to select the reference images which were captured at least approximate to the capture location (i.e., as indicated by GPS coordinates) determined at step 402. The reference images selected at step 403 may not necessarily have exactly the same GPS coordinates as the captured image 190. However, the GPS coordinates of the selected reference images may be within a predetermined threshold geographical radius (e.g., 100 meters) of the GPS coordinates of the captured image 190 indicating the reference images of the selected subset being captured approximate to the capture location of the captured image 190. In one implementation, the images selected at step 403 may be selected from the existing databases stored on the remote servers connected to the communications network 120. Upon selecting the reference images at step 403, the processor 105 may store the selected reference images in the memory 106.

The method 400 continues at peak determining step 404, where the processor 105 performs the step of determining any recurring patterns in the reference images selected at step 403. In particular, the processor 105 analyses metadata associated with the selected reference images to determine any periodic peaks such as weekly, monthly, or yearly peaks, for images captured at the capture location determined at step 401. The periodic peaks may be identified using any of the suitable pattern recognition methods described above.

Also at step 404, the processor 105 analyses the metadata associated with the selected reference images to determine if there are any isolated peaks in the reference images that occurred approximate to the capture time associated with the captured image 190. Again, the processor 105 makes the determination at step 404 regarding any isolated peaks by analysing the metadata associated with each of the selected reference images.

At determining step 405, if the processor 105 determines that the captured image 190 was captured during a periodic peak period as determined at step 404, then the method 400 proceeds to step 406. Again, the processor 105 makes the determination at step 405 by analysing the metadata associated with the captured image 190 and the metadata associated with each of the selected reference images. In particular, at step 405, the processor 105 determines whether the reference images captured within one of the periodic peak periods were captured at a time associated with (i.e., within a predetermined threshold period approximate to) the capture time of the captured image 190.

Then at retrieving step 405, the reference images that were captured within (i.e., within a predetermined threshold period approximate to) one of the periodic peak periods in which the image 190 was captured, are retrieved by the processor 105 from the reference image database configured within the hard disk drive 110. The images retrieved at step 405 may be stored within the memory 106. Accordingly, the reference images retrieved at step 405 are selected based on a recurring pattern of peaks in a number of images captured at the capture location determined at step 401.

As described above, where the captured image 190 is determined not to have been captured within one of the periodic periods, then the method 400 proceeds to step 407. At determining step 407, if the processor 105 determines that the captured image 190 was captured during an isolated peak period as determined at step 404, then the method 400 proceeds to retrieving step 408. Otherwise, the method 400 proceeds to step 409.

Then at retrieving step 408, the reference images that were captured within (i.e., within a predetermined threshold period approximate to) the isolated peak period in which the image 190 was captured are retrieved by the processor 105 from the reference image database configured within the hard disk drive 110. The images retrieved at step 408 may be stored within the memory 106. Accordingly, the reference images retrieved at step 408 are selected based on the isolated peak in number of images captured at the capture location determined at step 401.

As described above, where the processor 105 determines that there are no periodic peaks or no isolated peaks in captured reference images occurring at a time approximate to the capture time (i.e., within a predetermined threshold period) associated with the captured image 190, then the method 400 proceeds to step 409.

At retrieving step 409, any reference images that were captured within a predetermined threshold period of the capture time of the captured image 190 are retrieved by the processor 105 from the reference image database configured within the hard disk drive 110. The images retrieved at step 409 may be stored within the memory 106. Accordingly, the images retrieved at step 409 are selected based on being captured at the capture time determined at step 401.

Accordingly, the reference images retrieved by the processor 105 and stored within the memory 106 at any one of steps 406, 408 or 409, form another selected subset of the reference images stored within the reference image database configured within the hard disk drive 110.

The method 400 continues at the next step 410, where the processor 105 performs the step of determining one or more similar reference images from the selected subset of images stored at any one of steps 406, 408 or 409. The similar reference images are determined based on at least one characteristic of the captured image 190 using an image similarity comparison carried out between the captured image 190 and the other images of the selected subset stored in memory 106 at any one of steps 406, 408 or 409.

The similar reference images may be determined at step 410 using any suitable method. For example, US Patent Publication No. 2006/0020597 A1 discloses that there are two main categories that most image similarity methods fall under. The first category consists of methods which compare some statistical profile derived from images to be compared. The second category of image similarity methods consists of methods that identify features in an image and possibly relationships between features in the image, prior to comparing two images. Such features are identified by both identifying differences between the features of two images and the difference in how the features are related.

Colour histogram, as disclosed in the article entitled “Color indexing,” by M. Swain and D. Ballard, International Journal of Computer Vision, 7(1):11-32, 1991, is a statistical profiling method suitable for use in the described method 400. The method disclosed in Swain et al determines frequency colours occurring in an image by determining a histogram that describes distribution of colours within a particular image. Two images are compared by comparing the colour histograms of each of the images. The method disclosed by Swain et al has the advantage that the method is invariant to affine transforms being applied to the particular image. However, the method disclosed by Swain et al does not consider spatial relationship between colours of the particular image.

Examples of statistical profiling methods that may be suitable for use in the method 400 and that integrate color spatial relationships into the image similarity methods are disclosed in the following articles:

1) G. Pass and R. Zabih, “Histogram refinement for content-based image retrieval,” IEEE Workshop on Applications of Computer Vision, pages 96-120, 1996; 2) M. Stricker and A. Dimai, “Color indexing with weak spatial constraints,” SPIE Proceedings, 2670:29-40, 1996; and

3) J. R. Smith and S. F. Chang, “Visualseek: a fully automated content-based image query system,” by In Proc of ACM Multimedia 96, 1996.

Another statistical profiling method which attempts to improve on the colour historgram method described above is known as “colour correlogram”. The colour correlogram method is disclosed in an article entitled “Image indexing using color correlograms,” by J. Huang, S. R. Kumar, M. Mitra, W.-J. Zhu and R. Zabih, in Proc CVPR '97, 1997. In the method disclosed by Huang et al, a histogram-like structure that gives the probability distribution that a particular color has a pixel of another colour a certain distance away is constructed. The method disclosed by Huang et al is suitable for use in the method 400. However, the colour correlogram may be very large in size.

An edge orientation histogram, as disclosed in an article entitled “Images Similarity Detection Based on Directional Gradient Angular Histogram,” by J. Peng, B. Yu and D. Wang, Proc. 16^{th} Int. Conf. on Pattern Recognition (ICPR '02), and in an article entitled “Image Retrieval using Color and Shape,” A. K. Jain and A. Vailaya, Pattern Recognition, 29(8), 1996, builds a histogram that describes probability of a pixel having a particular gradient orientation. The edge orientation histogram method is good at capturing general shape tendencies in a visual image without being very sensitive to image brightness or colour.

A number of image similarity methods which are suitable for use at step 410 of the method 400 employ image segmentation or colour clustering to identify prominent colour regions in an image. Such image similarity methods involve dividing an image into salient regions, and determining a set of descriptors for each of one or more regions to describe the image. Examples of such image similarity methods are disclosed in the following articles: 1) “Image indexing and retrieval based on human perceptual color clustering,” by Y. Gong, G. Proietti and C. Faloutsos, In Proc. CVPR '98, 1998;

2) “A multiresolution color clustering approach to image indexing and retrieval,” by X. Wan and C. J. Kuo, In Proc. IEEE Int. Conf. Acoustics, Speech, Signals Processing, vol. 6, 1998;

3) “Integrating Color, Texture, and Geometry for Image Retrieval,” by N. Howe and D. Huttenlocher, In Proc. CVPR 2000, 2000;

4) “Percentile Blobs for Image Similarity,” by N. Howe, IEEE Workshop on Content-Based Access of Image and Video Databases, 1998;

5) “Blobworld: A System for Region-Based Image Indexing and Retrieval,” by C. Carson, M. Thomas, S. Belongie, J. M. Hellerstein and J. Malik, Proc. Visual Information Systems, pp. 509-516, June 1999, and

6) “Simplicity: Semantics-sensitive integrated matching for picture libraries,” by J. Z. Wang, Jia Li and Gio Wiederhold, IEEE Transactions on Pattern Analysis and Machine Intelligence (PAMI), 2001.

Another image similarity method that is suitable for use at step 410 of the method 400 is disclosed in an article entitled “Object Class Recognition by Unsupervised Scale-Invariant Learning,” by R. Fergus, P. Perona and A. Zisserman, In Proc. CVPR '03, 2003. Another image similarity method suitable for use at step 410 of the method 400 learns scale-invariant features from a set of visual images including a particular object or objects that are provided as a training set. This scale-invariant learning method is able to identify features in objects common to all images in a training set without user supervision. Images may then be classified according to objects that the images contain. The disadvantage of the scale-invariant learning method is that the scale-invariant learning method requires the definition of object classes and a training pass.

For any particular implementation of the method 400, it is possible to use any one or combination of the methods disclosed in the articles, patents or patent publication listed above to perform image similarity comparisons at step 410 of the method 400.

In one implementation, a method combining both colour and shape similarity, similar to that described in the article entitled “Image Retrieval using Color and Shape”, by A. K. Jain and A. Vailaya, Pattern Recognition, 29(8), 1996—is used at step 410 for determining one or more similar reference images from the selected subset of images stored at any one of steps 406, 408 or 409. In particular, colour is an important attribute for image similarity. Colour information in an image may be represented by three separate histograms. The colour histogram representations are invariant under rotation and translation of the image. Normalisation of the histogram provides scale invariance. For example, if H(i) is a histogram of an image, where index i represents a histogram bin, then the normalized histogram I is defined in accordance with Equation (1) below:

l(i)=H(i)/ΣᵢH(i) (1)

Letting I_{R}, I_{G}, and I_{B} represent the normalised colour histograms of an image, and C_{R}, C_{G}, and C_{B}, represent the normalised histograms of a comparison image. The similarity between the image and the comparison image may be determined using the following histogram intersection equation (i.e., Equation (2)), below:

$${S}_{C} ( I , C ) = \frac{\begin{matrix}{\sum }_{r}^{ } min ( {I}_{R} ( r ) , {C}_{R} ( r ) ) + {\sum }_{g}^{ } min ( {I}_{G} ( g ) , \\ {C}_{G} ( g ) ) + {\sum }_{b}^{ } min ( {I}_{B} ( b ) , {C}_{B} ( b ) )\end{matrix}}{Min ( \vert I \vert , \vert C \vert ) * 3} \qquad ( 2 )$$

where the value of S_{C}(I, C) lies in the interval [0, 1], such that if the histograms I and C are identical then S(I, C) is 1.

In the absence of colour information or presence of images with similar colours, shape content of the images may be required to determine the one or more similar reference images at step 410. A histogram of the edge directions in an image may be used to represent the shape attribute. The edge information for the image may then be generated using a Canny edge detection operator (as developed by John F. Canny in 1986). A histogram intersection method similar to the one described above may then be used for shape similarity to determine the one or more similar reference images. Such a shape similarity method may also be used for matching parts of two images. However, matching the histograms of edge directions is not rotation or scale invariant. Normalising the histograms with respect to the number of edge points in the image may be used to make such a method scale invariant. Rotation of an image only shifts the histogram bins, so a match across all possible shifts solves any rotation invariance problem.

In one implementation, results of colour and shape similarity between images may be combined to determine one or more similar reference images at step 410. In particular, a total similarity result may determined in accordance with Equation (3) below:

$${S}_{T} = \frac{{w}_{c} * {S}_{c} + {w}_{s} * {S}_{s}}{{w}_{c} + {w}_{s}}$$

where w_{c} and wₛ are weights assigned to colour based similarity and shape based similarity, respectively.

The method 400 continues at interest determining step 411, where the processor 105 performs the step of determining how interesting other users (i.e., level of interest of the other users) are likely to find the similar images determined in step 410. In one implementation, an “image star rating” associated with each of the similar images is used to determine how interesting other users are likely to find the similar images. Accordingly, images with a higher image star rating are considered to have a higher level of interest. Alternatively, values representing number of times any particular image has been viewed or referenced, or number of times other users have commented on the particular image may be used as indicators to determine the level of interest in the particular similar image.

At averaging step 412, the processor 105 performs the step of determining an average value representing an average of the ratings associated with each of the similar images determined in step 410. The average determined at step 412 may be stored in the memory 106.

The method 400 concludes at the rating step 413, where the processor 105 performs the step of rating the captured image 190 based on the rating values (e.g., the image star ratings) associated with the similar reference images. In particular, the average value determined at step 412 may be applied as a rating to the captured image 190. As described above, the ratings applied to each of the similar images and, therefore the average determined at step 412, is based on the level of interest in the similar images by other users. The rating applied to the captured image 190 may be stored with the captured image, for example, as metadata within the image database configured within the hard disk drive 110.

Once the interest rating has been applied to the captured image 190 and any more images captured by the user 199 and uploaded as described above, the uploaded images may be filtered and/or ranked in order. Such ranking and filtering assists the user 199 in determining which images are likely to be most suitable for activities such as printing to hardcopy, incorporation into a photo book, slideshow or the like.

### INDUSTRIAL APPLICABILITY

The arrangements described are applicable to the computer and data processing industries and particularly for the image processing.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of’. Variations of the word “comprising”, such as “comprise” and “comprises” have correspondingly varied meanings.

1. A method of rating a captured image, said method comprising the steps of:
accessing a database of reference images, one or more of the reference images having an associated rating value;
selecting one or more of the reference images to form at least one subset of reference images based on metadata associated with the reference images, the reference images of said subset being captured at an event determined by a function of a capture location of the captured image and a time associated with a capture time of the captured image;
determining one or more similar reference images from the selected subset based on at least one characteristic of the captured image; and
rating the captured image based on the rating values associated with the similar reference images.

2. The method according to claim 1, wherein the event is determined based on a recurring pattern of peaks in a number of reference images captured at said capture location.

3. The method according to claim 1, wherein the event is determined based on an isolated peak in number of reference images captured at said capture location.

4. The method according to claim 1, wherein the event is determined based on being captured at said capture time.

5. An apparatus for rating a captured image, said apparatus comprising:
accessing means for accessing a database of reference images, one or more of the reference images having an associated rating value;
selecting means for selecting one or more of the reference images to form at least one subset of reference images based on metadata associated with the reference images, the reference images of said subset being captured at an event determined by a function of a capture location of the captured image and a time associated with a capture time of the captured image;
determining means for determining one or more similar reference images from the selected subset based on at least one characteristic of the captured image; and
rating means for rating the captured image based on the rating values associated with the similar reference images.

6. A system for rating a captured image, said system comprising:
a memory for storing data and a computer program;
a processor coupled to said memory for executing said computer program, said computer program comprising instructions for:
accessing a database of reference images, one or more of the reference images having an associated rating value;
selecting one or more of the reference images to form at least one subset of reference images based on metadata associated with the reference images, the reference images of said subset being captured at an event determined by a function of a capture location of the captured image and a time associated with a capture time of the captured image;
determining one or more similar reference images from the selected subset based on at least one characteristic of the captured image; and
rating the captured image based on the rating values associated with the similar reference images.

7. A computer readable medium comprising a computer program stored thereon for rating a captured image, said program comprising:
code for accessing a database of reference images, one or more of the reference images having an associated rating value;
code for selecting one or more of the reference images to form at least one subset of reference images based on metadata associated with the reference images, the reference images of said subset being captured at an event determined by a function of a capture location of the captured image and a time associated with a capture time of the captured image;
code for determining one or more similar reference images from the selected subset based on at least one characteristic of the captured image; and
code for rating the captured image based on the rating values associated with the similar reference images.
